(19) United States
(12) Patent Application Publication
(10) Pub. No.: US 2026/0366956 A1
(43) Pub. Date: Nov. 19, 2026

(54) SYSTEM AND METHOD FOR MEASURING OPTICAL CHARACTERISTICS OF TRANSPARENT MEASUREMENT OBJECT, AND PROGRAM

(71) Applicant: KONICA MINOLTA, INC., Tokyo (JP)

(72) Inventors: Syogo MOCHIDA, Tokyo (JP); Takushi UDA, Tokyo (JP); Kenji KONNO, Tokyo (JP)

(21) Appl. No.: 19/138,766

(22) PCT Filed: Nov. 30, 2023
(86) PCT No.: PCT/JP2023/042838

§ 371 Date: Jun. 13, 2025

(30) Foreign Application Priority Data
Dec. 14, 2022 (JP) 2022-199430

(51) Int. Cl. G01M 11/02; G01B 11/02

(52) U.S. Cl. CPC G01M 11/0228; G01B 11/026; G01M 11/0207

(57) ABSTRACT

To provide a system and a method for measuring optical characteristics of a transparent measurement object, and a program, which enable high-speed measurement, and also enable highly accurate measurement even when a measurement object is changed, and distance information is changed. The system includes a distance calculator that calculates a first distance from an imaging apparatus to a transparent measurement object based on a size of a reference portion on an image captured when the reference portion having a known size is disposed at a disposition position of a transparent measurement object set between a display apparatus and an imaging apparatus capable of performing electronic focus control, and is imaged by the imaging apparatus, on a focal length of the imaging apparatus, and on an actual size of the reference portion, and calculating a third distance from the display apparatus to the transparent measurement object based on the first distance and a second distance from the imaging apparatus to the display apparatus, and calculator for calculating a refractive power distribution of the transparent measurement object based on an image captured by the imaging apparatus in a state where a display pattern is displayed on the display apparatus and the transparent measurement object is disposed, on an image captured by the imaging apparatus in a state where the display pattern is displayed on the display apparatus but the transparent measurement object is absent, and on the third distance.

### TECHNICAL FIELD

The present invention relates to a system and a method for measuring optical characteristics of a transparent measurement object and to a program, which enable measurement of a refractive power distribution of a transparent measurement object such as glass.

### BACKGROUND ART

When an object is observed through a light-transmitting object such as glass, an image may appear distorted if the quality of the light-transmitting object is poor. This phenomenon is called perspective distortion, which is one of the quality items of glass and the like of an automobile.

Conventionally, an apparatus for roughly inspecting a large area in front of a driver or a passenger seat has been widely used as an inspection apparatus for glass of an automobile. However, in recent years, with the spread of automatic driving, driving assistants, and the like, there have been increasing demands for the quality of glass in front of an in-vehicle camera so as not to cause distortion in an image detected by the in-vehicle camera, and there have been needs to inspect such detailed parts with high spatial resolution.

As a system capable of such high-resolution measurement, Patent Literature 1 proposes a system in which images of a plurality of periodic patterns having different phases are acquired in the presence and absence of glass and the acquired images are calculated to calculate an optical quality value such as refractive power. In this system, in order to measure, with high resolution, not the entire surface of the glass but a specific small area such as the vicinity of an area where the in-vehicle camera is attached (the vicinity of a black ceramic portion), a step of positioning a camera exists in addition to normal measurement. A measurement area is within a depth of focus of the camera, and one or more images of a glass surface are acquired to perform positioning of the camera by an articulated arm or the like. Thus, the quality of glass in the vicinity of the in-vehicle camera can be measured with high spatial resolution (within 0.1 mm order).

### CITATION LIST

### Patent Literature

Patent Literature 1: FR 3101420 A1

### SUMMARY OF INVENTION

### Technical Problem

However, in the system described in Patent Literature 1, since it is necessary to move the camera such that a measurement object is within the depth of focus of the camera, there is a problem in that high-speed measurement is difficult. In addition, since when the measurement object is changed, distance information is changed, and a variation in measurement parameters occurs, there is also a problem in that highly accurate measurement is difficult. The present invention has been made to solve such problems, and an object of the present invention is to provide a system and a method for measuring optical characteristics of a transparent measurement object, and a program, which enable high-speed measurement, and also enable highly accurate measurement even when a measurement object is changed and distance information is changed.

### Solution to Problem

The above-described object is achieved by the following means.
(1) A system for measuring optical characteristics of a transparent measurement object, the system including:
   a display apparatus capable of displaying a display pattern in a light emission manner;
   an imaging apparatus disposed at a distance from the display apparatus and capable of performing electronic focus control;
   distance calculation means for calculating a first distance from the imaging apparatus to the transparent measurement object disposed at a disposition position of the transparent measurement object set between the display apparatus and the imaging apparatus, based on a size of a reference portion on an image captured when the reference portion having a known size is disposed at the disposition position and is imaged by the imaging apparatus, on a focal length of the imaging apparatus, and on an actual size of the reference portion, and calculating a third distance from the display apparatus to the transparent measurement object based on the first distance calculated and a second distance from the imaging apparatus to the display apparatus; and
   calculation means for calculating a refractive power distribution of the transparent measurement object based on an image captured by the imaging apparatus in a state where the display pattern is displayed on the display apparatus and the transparent measurement object is disposed at the disposition position, on an image captured by the imaging apparatus in a state where the display pattern is displayed on the display apparatus but the transparent measurement object is absent, and on the third distance calculated by the distance calculation means.
(2) The system for measuring optical characteristics of a transparent measurement object according to the aforementioned item 1, wherein the reference portion and the transparent measurement object are imaged by the imaging apparatus in a state where the electronic focus control is performed such that the reference portion and the transparent measurement object are within a depth of focus of the imaging apparatus.
(3) The system for measuring optical characteristics of a transparent measurement object according to the aforementioned item 1 or 2, wherein the display apparatus is subjected to gamma adjustment so as to maintain linearity between an input luminance value and an output luminance value at a time of imaging by the imaging apparatus.
(4) The system for measuring optical characteristics of a transparent measurement object according to the aforementioned item 1 or 2, wherein the display pattern includes a plurality of patterns in which brightness and darkness change sinusoidally and phases of a sinusoidal wave are different from each other, and a spatial frequency is adjusted such that contrast is 10% or more at a time of imaging by the imaging apparatus.
(5) The system for measuring optical characteristics of a transparent measurement object according to the aforementioned item 1 or 2, wherein the distance calculation means calculates the second distance based on a size of a pattern on an image captured when the pattern having a known size displayed on the display apparatus is imaged by the imaging apparatus for which the electronic focus control is performed such that a focal position is located on the display apparatus in a state before the transparent measurement object is imaged and where the transparent measurement object is absent, on a focal length of the imaging apparatus, and on an actual size of the pattern.
(6) The system for measuring optical characteristics of a transparent measurement object according to the aforementioned item 1 or 2, wherein the transparent measurement object is a windshield of an automobile, and
   the reference portion is a black ceramic portion in which a plurality of reference points formed on the windshield and a dimension of an interval between the reference points are known.
(7) The system for measuring optical characteristics of a transparent measurement object according to the aforementioned item 1 or 2, wherein when granular noise is present in the refractive power distribution of the transparent measurement object that is a calculation result, the calculation means compares absolute values of differences between a local median in the refractive power distribution and surrounding pixel values, determines, using the differences, whether a pixel is an abnormal pixel based on a threshold value, and when the pixel is determined to be the abnormal pixel, performs processing of replacing a pixel value of the abnormal pixel with an average value of surrounding pixel values excluding the abnormal pixel.
(8) A method for measuring optical characteristics of a transparent measurement object, the method including:
   a reference portion imaging step of disposing a reference portion having a known size at a disposition position of the transparent measurement object set between a display apparatus capable of displaying a display pattern in a light emission manner and an imaging apparatus disposed at a distance from the display apparatus and capable of performing electronic focus control, and imaging the reference portion by the imaging apparatus;
   a third distance calculation step of calculating a first distance from the imaging apparatus to the transparent measurement object disposed at the disposition position, based on a size of the reference portion on an image captured at a time of imaging in the reference portion imaging step, a focal length of the imaging apparatus, and an actual size of the reference portion, and calculating a third distance from the display apparatus to the transparent measurement object based on the first distance calculated and a second distance from the imaging apparatus to the display apparatus;
   a measurement object imaging step of imaging by the imaging apparatus in a state where the display pattern is displayed on the display apparatus and the transparent measurement object is disposed at the disposition position and in a state where the display pattern is displayed on the display apparatus but the transparent measurement object is absent; and
   a calculation step of calculating a refractive power distribution of the transparent measurement object based on an image in which the transparent measurement object is present and an image in which the transparent measurement object is absent, the images having been captured by imaging in the measurement object imaging step, and on the third distance calculated in the distance calculation step.
(9) A program for causing a computer to execute:
   a reference portion image acquiring step of acquiring an image of a reference portion captured by an imaging apparatus in a state where the reference portion having a known size is disposed at a disposition position of a transparent measurement object set between a display apparatus and the imaging apparatus, the display apparatus being capable of displaying a display pattern in a light emission manner, the imaging apparatus being disposed at a distance from the display apparatus and capable of performing electronic focus control;
   a distance calculation step of calculating a first distance from the imaging apparatus to the transparent measurement object disposed at the disposition position, based on a size of the reference portion on the image acquired in the reference portion image acquiring step, a focal length of the imaging apparatus, and an actual size of the reference portion, and calculating a third distance from the display apparatus to the transparent measurement object based on the first distance calculated and a second distance from the imaging apparatus to the display apparatus;
   a measurement object image acquiring step of acquiring an image captured by the imaging apparatus in a state where the display pattern is displayed on the display apparatus and the transparent measurement object is disposed at the disposition position, and an image captured by the imaging apparatus in a state where the display pattern is displayed on the display apparatus but the transparent measurement object is absent; and
   a calculation step of calculating a refractive power distribution of the transparent measurement object based on the image in which the transparent measurement object is present and the image in which the transparent measurement object is absent, the images having been acquired in the measurement object image acquiring step, and on the third distance calculated in the distance calculation step.

### Advantageous Effects of Invention

According to the inventions as recited in the aforementioned items (1) and (8), since the imaging apparatus can perform the electronic focus control, it is possible to automatically make an adjustment such that the transparent measurement object is within the depth of focus of the imaging apparatus. Therefore, it is not necessary to move the imaging apparatus by an articulated arm or the like as in the technology described in Patent Literature 1, and high-speed measurement is enabled.

Furthermore, the first distance from the imaging apparatus to the transparent measurement object disposed at the disposition position is calculated based on the size of the reference portion on the image captured when the reference portion having the known size is disposed at the disposition position of the transparent measurement object set between the display apparatus capable of displaying a display pattern in a light emission manner and the imaging apparatus, and is imaged by the imaging apparatus, on the focal length of the imaging apparatus, and on the actual size of the reference portion, and the third distance from the display apparatus to the transparent measurement object is calculated based on the first distance calculated and the second distance from the imaging apparatus to the display apparatus. The third distance is used to calculate the refractive power distribution of the transparent measurement object together with the image captured by the imaging apparatus in the state where the display pattern is displayed on the display apparatus and the transparent measurement object is disposed at the disposition position and the image captured by the imaging apparatus in the state where the display pattern is displayed on the display apparatus but the transparent measurement object is absent.

That is, even when the transparent measurement object to be measured is changed, the third distance, from the display apparatus to the transparent measurement object, required for the calculation of the refractive power distribution can be calculated with high accuracy each time, and thus highly accurate measurement is enabled.

According to the invention as recited in the aforementioned item (2), the reference portion and the transparent measurement object are imaged by the imaging apparatus in the state where the electronic focus control is performed such that the reference portion and the transparent measurement object are within the depth of focus of the imaging apparatus, and therefore, since the reference portion is within the depth of focus, the first distance from the imaging apparatus to the reference portion can be calculated with high accuracy, and consequently, the third distance from the display apparatus to the transparent measurement object can be calculated with high accuracy. In addition, since the transparent measurement object is imaged in the state where the transparent measurement object is within the depth of focus, an appropriate captured image of the transparent measurement object can be obtained, and consequently, highly accurate measurement of the refractive power distribution is enabled.

According to the invention as recited in the aforementioned item (3), since the display apparatus is subjected to gamma adjustment so as to maintain linearity between the input luminance value and the output luminance value at the time of imaging by the imaging apparatus, a more ideal display pattern can be displayed on the display apparatus, and a further highly accurate refractive power distribution can be obtained.

According to the invention as recited in the aforementioned item (4), since the display pattern includes the plurality of sinusoidal patterns in which brightness and darkness change sinusoidally and the phases of the sinusoidal wave are different from each other, and the spatial frequency is adjusted such that contrast is 10% or more at the time of imaging by the imaging apparatus, a further highly accurate refractive power distribution can be obtained.

According to the invention as recited in the aforementioned item (5), since the second distance is calculated based on the size of the pattern on the image captured when the pattern having the known size displayed on the display apparatus is imaged by the imaging apparatus for which the electronic focus control is performed such that the focal position is located on the display apparatus in the state before the transparent measurement object is imaged and where the transparent measurement object is absent, on the focal length of the imaging apparatus, and on the actual size of the pattern, the second distance can be calculated each time before the measurement and the third distance can be calculated in the state where the second distance is accurate. Therefore, further highly accurate measurement of the refractive power distribution is enabled.

According to the invention as recited in the aforementioned item (6), since the reference portion is the black ceramic portion in which the plurality of reference points formed on the windshield of the automobile, which is the transparent measurement object, and the dimension of the interval between the reference points are known, it is not necessary to separately provide the reference portion by using the existing black ceramic portion as the reference portion, and in addition, it is possible to simultaneously perform the imaging of the transparent measurement object and the reference portion, which leads to the shortening of the entire measurement time.

According to the invention as recited in the aforementioned item (7), when the granular noise is present in the refractive power distribution of the transparent measurement object that is the calculation result, the absolute values of the differences between the local median in the refractive power distribution and the surrounding pixel values are compared, determination is made, using the differences, whether the pixel is the abnormal pixel based on the threshold value, and when the pixel is determined to be the abnormal pixel, the pixel value of the abnormal pixel is replaced with the average value of surrounding pixel values excluding the abnormal pixel, and therefore, even if the granular noise due to dust, dirt, or the like is present in the refractive power distribution, the granular noise can be reduced.

According to the invention as recited in the aforementioned item (9), it is possible to cause a computer to execute: the processing of acquiring an image of a reference portion captured by an imaging apparatus in a state where the reference portion having a known size is disposed at a disposition position of a transparent measurement object set between a display apparatus and the imaging apparatus, the display apparatus being capable of displaying a display pattern in a light emission manner, the imaging apparatus being capable of performing electronic focus control; the processing of calculating the first distance from the imaging apparatus to the transparent measurement object, based on the size of the reference portion on the image captured, the focal length of the imaging apparatus, and the actual size of the reference portion, and calculating the third distance from the display apparatus to the transparent measurement object based on the first distance calculated and the second distance from the imaging apparatus to the display apparatus; the processing of acquiring the image captured by the imaging apparatus in the state where the display pattern is displayed on the display apparatus and the transparent measurement object is disposed at the disposition position and the image captured by the imaging apparatus in the state where the display pattern is displayed on the display apparatus but the transparent measurement object is absent; and the processing of calculating the refractive power distribution of the transparent measurement object based on the image in which the transparent measurement object is present and the image in which the transparent measurement object is absent, the images having been acquired, and on the third distance calculated.

### BRIEF DESCRIPTION OF DRAWINGS

FIG. 1 is a diagram illustrating a schematic configuration of a system for measuring optical characteristics of a transparent measurement object according to an embodiment of the present invention.

FIG. 2 is a schematic explanatory diagram of an algorithm for calculating a refractive power distribution (diopter map).

FIG. 3 is a diagram for explaining a distance relationship between a display apparatus, an imaging apparatus, and a transparent measurement object.

FIG. 4 is a diagram for explaining how to obtain the diopter map.

FIG. 5 is a diagram illustrating a transparent measurement object used for explaining a specific example of measurement of the diopter map.

FIG. 6(A) is a diagram illustrating a displacement amount map when phase unwrapping is performed on a phase difference image; and FIG. 6(B) is a cross-sectional view thereof.

FIG. 7 is a diagram for explaining a method of calculating a distance from the imaging apparatus to the transparent measurement object.

FIG. 8 is a flowchart illustrating processing up to calculation of the diopter map.

FIG. 9(A) is a front view of a transparent measurement object used in an experiment; and FIG. 9(B) is an enlarged view of an image captured by the imaging apparatus.

FIG. 10(A) is a screen view of a display apparatus displaying a rectangular pattern; and FIG. 10(B) illustrates an image captured when the rectangular pattern is imaged by the imaging apparatus.

FIG. 11(A) illustrates images captured by the imaging apparatus in a state where four types of display patterns (sinusoidal patterns) in which brightness and darkness change sinusoidally are displayed on the display apparatus and the transparent measurement object is present; and FIG. 11(B) illustrates images captured by the imaging apparatus in a state where the four types of display patterns (sinusoidal patterns) in which brightness and darkness change sinusoidally are displayed on the display apparatus and the transparent measurement object is absent.

FIGS. 12(A) and 12(B) illustrate images representing extraction results of extracting amplitudes, offsets, and phases by applying a four-step phase shift method to the images illustrated in FIG. 8(A) and FIG. 8(B), respectively.

FIG. 13(A) is a diagram for explaining the size of a reference portion formed on a plane of the transparent measurement object; and FIG. 13(B) illustrates an offset image for obtaining the apparent size of the reference portion when viewed from the imaging apparatus.

FIG. 14(A) illustrates a phase difference image obtained when a difference is calculated between phase images captured by the imaging apparatus in the presence and absence of the transparent measurement object; and FIG. 14(B) illustrates an image obtained by performing phase unwrapping on the phase difference image.

FIG. 15(A) is a diagram illustrating a state where a 1d-cut is drawn from the center of the phase image in the absence of the transparent measurement object; and FIG. 15(B) is a 1d-cut cross-sectional view of FIG. 15(A).

FIG. 16 is a diagram illustrating a displacement-amount distribution subjected to an averaging filter.

FIG. 17(A) illustrates the same grid image as that illustrated in FIG. 6(B); and FIG. 17(B) illustrates an image obtained by performing calculation of the diopter map.

FIG. 18 is an explanatory diagram for explaining an example of a method of coping with a case where granular (salt-and-pepper) noise is present in the diopter map.

FIG. 19(A) is a diagram illustrating the refractive power distribution before the processing described in FIG. 15 is performed; and FIG. 19(B) is a diagram illustrating the diopter map after the processing.

FIG. 20 is a diagram illustrating an experimental optical system used for performing y adjustment of the display apparatus in Example 3.

FIG. 21(A) is a diagram illustrating an example of a plurality of display patterns displayed on the display apparatus in the experimental optical system illustrated in FIG. 17; and FIG. 21(B) illustrates images captured when the display patterns are imaged.

FIG. 22 is a diagram illustrating a y curve obtained in an experiment.

FIG. 23(A) is a diagram illustrating a sinusoidal pattern in a case where no gamma adjustment is performed; and FIG. 23(B) is a diagram illustrating a sinusoidal pattern in a case where gamma adjustment is performed.

FIG. 24 is a diagram illustrating an experimental optical system used for investigating an influence on an output value due to a difference in spatial frequency of a sinusoidal pattern displayed on the display apparatus 10 in Example 4.

FIG. 25(A) is a diagram illustrating a state where a sinusoidal pattern with a cycle of 25 px is displayed on the display apparatus; and FIG. 25(B) is a diagram illustrating a state where a sinusoidal pattern with a cycle of 50 px is displayed on the display apparatus.

FIGS. 26(A) and 26(B) each illustrate an image (initial phase α=0) captured when a transparent measurement object (lens) is imaged by the imaging apparatus in a state where the sinusoidal pattern is displayed on the display apparatus in the experimental optical system illustrated in FIG. 21, in which FIG. 26(A) illustrates an image in the case where the cycle of the sinusoidal pattern is 25 px; and FIG. 26(B) illustrates an image in the case where the cycle of the sinusoidal pattern is 50 px.

FIG. 27(A) is a diagram illustrating a refractive power distribution of the image in the case where the cycle of the sinusoidal pattern illustrated in FIG. 23(A) is 25 px, and its horizontal-direction cross-sectional view; and FIG. 27(B) is a diagram illustrating a diopter map of the image in the case where the cycle of the sinusoidal pattern illustrated in FIG. 23(B) is 50 px, and its horizontal-direction cross-sectional view.

FIGS. 28(A) and 28(B) each illustrate a comparison result of contrast in a certain cross section of a sinusoidal image (initial phase α=0) in the absence of the transparent measurement object, in which FIG. 28(A) is a diagram in the case where the cycle of the sinusoidal pattern is 25 px; and FIG. 28(B) is a diagram in the case where the cycle of the sinusoidal pattern is 50 px.

### DESCRIPTION OF EMBODIMENTS

Hereinafter, an embodiment of the present invention will be described with reference to the drawings.

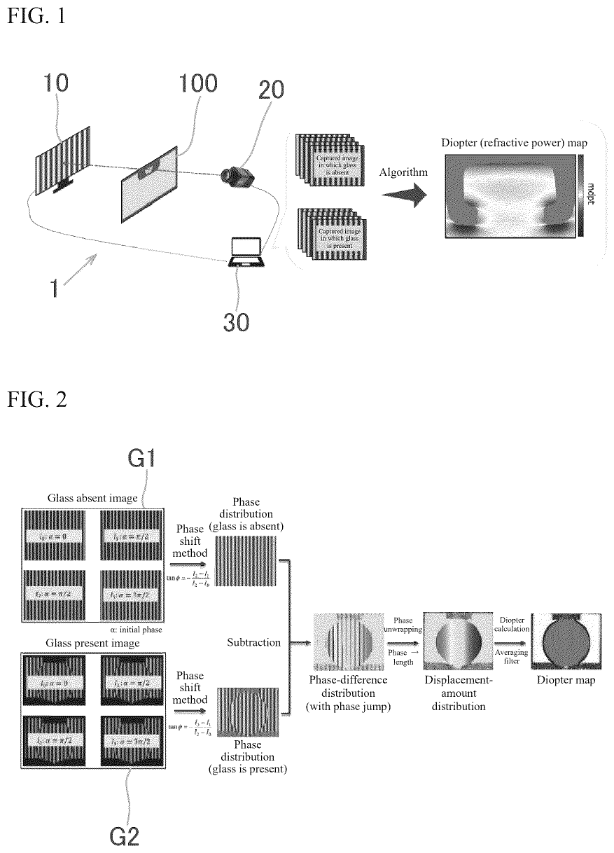

FIG. 1 is a diagram illustrating a schematic configuration of a system 1 for measuring optical characteristics of a transparent measurement object according to an embodiment of the present invention.

In FIG. 1, the system 1 for measuring optical characteristics includes a display 10 as a digital display apparatus, a camera 20 as an imaging apparatus, and a personal computer (hereinafter, also referred to as a PC) 30.

The display 10 displays a display pattern such as a sinusoidal pattern or a pattern, which will be described later, in a light emission manner, and is constituted by an LED panel or the like.

The camera 20 includes an imaging sensor having a large number of pixels, outputs image data corresponding to the amount of light received by each pixel, and is disposed to face the display 10 at a distance from the display 10. The camera 20 is provided with an electronic focus control function with which the focus of a lens can be automatically adjusted and controlled such that a subject is within a depth of focus.

The PC 30 performs the light emission control of the display 10 and the imaging control of the camera 20, and measures (calculates) a refractive power distribution of a transparent measurement object 100 using a predetermined algorithm based on an image of the transparent measurement object 100 captured by the camera 20. Note that the refractive power is also referred to as diopter, and the refractive power distribution is also referred to as a diopter map or a refractive power map.

The transparent measurement object 100 is a measurement object formed of a transparent substance such as glass, but the entire measurement object may not be transparent and may have a non-transparent portion in a part of a measurement region. In this embodiment, a windshield of an automobile is used as an example of the transparent measurement object 100. At the time of measurement, the transparent measurement object 100 is disposed between the display 10 and the camera 20. In the following description, the transparent measurement object is also simply referred to as a measurement object or glass.

In addition, as an algorithm for calculating the diopter map, an algorithm based on the phase shift method is used. The outline of this algorithm will be described below with reference to FIG. 2.

That is, a display pattern (sinusoidal pattern) in which brightness and darkness change sinusoidally is displayed on the display 10, and sinusoidal patterns are sequentially displayed by changing the phase of the sinusoidal pattern by, for example, π/2. In the example of FIG. 2, four sinusoidal patterns are used (four-step phase shift method). Next, images of the sinusoidal patterns of the respective phases displayed on the display 10 are captured by the camera 20 in a case where the glass 100 is disposed between the display 10 and the camera 20 and in a case where the glass 100 is not disposed between the display 10 and the camera 20.

In FIG. 2, G1 indicates an image (glass absent image) obtained by the camera 20 in a state where the glass 100 is not disposed, and G2 indicates an image (glass present image) obtained by the camera 20 in a state where the glass 100 is disposed.

Next, the PC 30 acquires both of the captured images G1 and G2 and calculates a diopter map. To be more specific, phase distributions are obtained from both the images G1 and G2 by the phase shift method, and then subtracted to obtain a phase-difference distribution (with phase jump), and further phase unwrapping is performed to obtain a displacement-amount distribution, and a diopter calculation is performed using an averaging filter to obtain a diopter map.

The above example shows the case of acquiring the strain distribution in the horizontal direction, but the strain in the vertical direction is also measured by using a sinusoidal pattern in a direction orthogonal thereto.

As described above, according to the phase shift method, the shape or the like of a measurement target can be measured with high accuracy by projecting a plurality of sinusoidal patterns having different phases from the display 10 onto the measurement target a plurality of times and imaging the states by the camera 20. In particular, when the measurement target is the transparent measurement object 100 such as glass, the phase delay of the light wave due to the refractive index change inside the transparent portion can be quantified.

Note that the algorithm using the above-described phase shift method is known, and thus detailed description thereof will be omitted.

In this embodiment, the glass 100 is set so as to be within the depth of focus of the lens of the camera 20. Therefore, the light of the sinusoidal pattern displayed on the display 10 is basically defocused. Since the phase shift method is based on the premise that an ideal sinusoidal pattern is used, it is desirable that the aperture in the camera 20 is reduced as much as possible and the depth of field is increased as much as possible (the value of the F-number is increased).

Further, it is desirable that the spatial frequency of the sinusoidal wave in the sinusoidal pattern is set to a spatial frequency at which the brightness and darkness can be sufficiently recognized for the above-described reason.

With respect to the number of pixels of the camera 20 and the distance between the camera 20 and the transparent measurement object 100, in order to measure the transparent measurement object 100 with high resolution, it is desirable that the distance between the glass 100 and the camera 20 is as close as possible such that the transparent measurement object 100 appears as large as possible in the field of view of the camera 20. It is desirable that the number of pixels of the camera 20 is as large as possible.

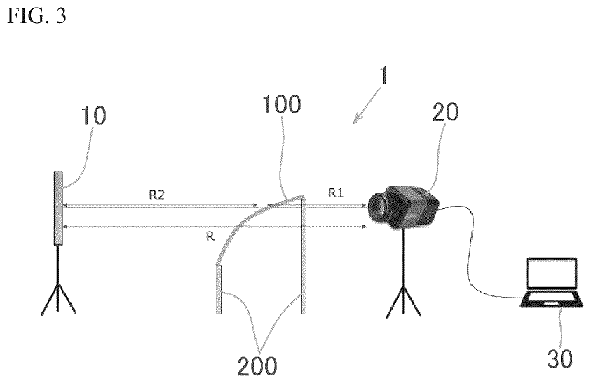

In this embodiment, as illustrated in FIG. 3, let R be the distance between the display 10 and the camera 20 (corresponding to a second distance), R1 be the distance between the camera 20 and the glass 100 (corresponding to a first distance), and R2 be the distance between the display 10 and the glass 100 (corresponding to a third distance). The distances between the display 10 and the camera 20 and between the camera 20 and the glass 100 are respectively the distances from the lens of the camera 20 to the display 10 and the glass 100.

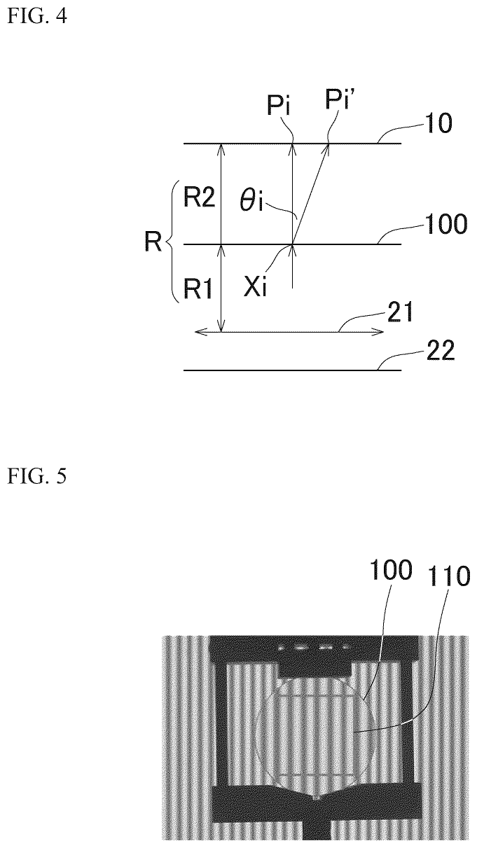

Next, the diopter will be described. The diopter (refractive power, degree) is a reciprocal of a focal length of a lens. The reciprocal of the focal length is related to a change in lens position and the amount of light bending. In order to obtain the diopter map on the glass 100, a model illustrated in FIG. 4 is considered.

In the model illustrated in FIG. 4, reference sign 21 denotes a lens of the camera 20, and reference sign 22 denotes an imaging sensor (a CCD in this embodiment). Further, it is assumed that any point on the glass 100 is Xi, a position on the display 10 when light is not displaced by the glass 100 is Pi, an actual displaced position is Pi′, and an angle between the line segment XiPi and the line segment XiPi′ is θi. As described above, the distances between the display 10 and the camera 20, between the camera 20 and the glass 100, and between the display 10 and the glass 100 are R, R1, and R2, respectively.

A diopter Di on the glass 100 is defined as follows.

That is, since Di=1/f≈δθi/δXi, the diopter Di is expressed by the following expression.

$${D}_{i} - \frac{{δθ}_{i}}{δ {X}_{i}} - \frac{{θ}_{i + 1} - {θ}_{i}}{{X}_{i + 1} - {X}_{i}} \qquad [ Mathematical Expression 1 ]$$

When ΔQi=Pi′−Pi, since θi=ΔQi/R2 approximately holds, the diopter Di is expressed by the following expression.

$${D}_{i} = \frac{Δ {Q}_{i + 1} - Δ {Q}_{i}}{R 2 ( {X}_{i + 1} - {X}_{i} )} \qquad [ Mathematical Expression 2 ]$$

In the above expression, (ΔQi+1−ΔQi) is “the displacement amount on the display 10”, (ΔXi+1−ΔXi) is “the unit section change on the glass 100”, and R2 is “the distance between the display 10 and the glass 100”, so that the diopter Di on the glass 100 can be calculated based on “the displacement amount on the display 10”, “the unit section change on the glass 100”, and “the distance between the display 10 and the glass 100”.

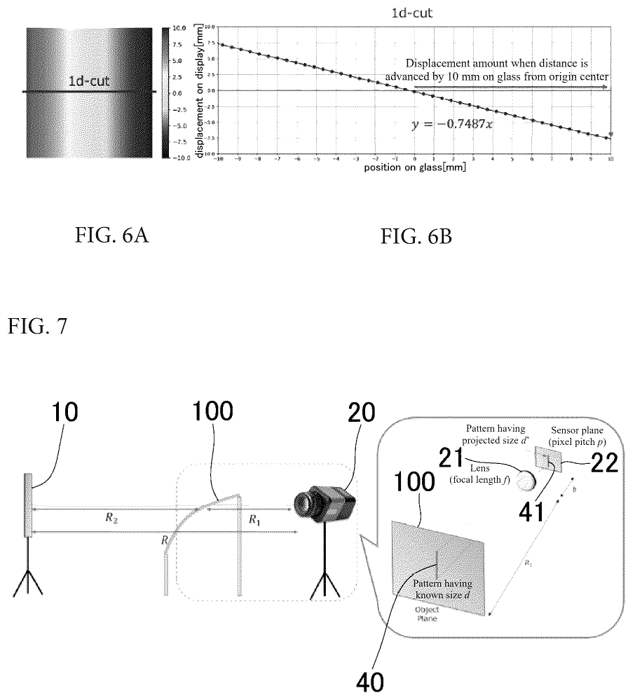

A specific example will be described. FIG. 6(A) is a diagram illustrating a displacement amount map when the phase shift method is applied to a black frame portion 110 of a plano-convex spherical lens 100 having a 50-mm diameter and a 2000-mm(=500 mdpt) focal length, which is illustrated in FIG. 5 as the transparent measurement object 100, and phase unwrapping is performed on the obtained phase difference image, and FIG. 6(B) is a cross-sectional view thereof.

Now, a diopter value is calculated from the displacement amount when a distance is advanced by 10 mm from the center origin on the lens 100. That is, it is assumed that Xi=0 and X(i+1)=10 mm.

At this time, as seen from the cross-sectional view of FIG. 6(B), the displacement amount at X(i+1) is ΔQ(i+1)≈7.487 mm, and since there is no displacement at the origin (Xi=0) of the lens center, ΔQi=0 mm. Assuming that R2=1.48 m, the diopter value Di is calculated as follows:

Di=(−7.487 mm)/(1.48*10 mm)=−0.5058 [dpt]=−506 [mdpt].

As described above, it is necessary to obtain the distance R2 between the display 10 and the glass 100 in order to calculate the diopter map. In this embodiment, the distance R2 between the display 10 and the glass 100 is obtained as follows. However, the glass plane of the transparent measurement object 100 is set so as to be within the depth of focus of the camera 20. This setting can be performed by the electronic focus control of the camera 20 without the need to move the camera 20 by a moving device such as an articulated arm, thus enabling high-speed measurement. It is also assumed that the pixel pitch of the camera 20 is known.

Then, the following calculation is performed in parallel with the calculation of the diopter map.
(1) As illustrated in FIG. 7, the glass 100 is disposed having, on a glass plane, a pattern (corresponding to a reference portion) 41 of a known size d, and an image of a sinusoidal pattern displayed on the display 10 is captured by an imaging sensor 22 of the camera 20.
(2) The phase shift method is applied to the captured image to extract an offset term.
(3) From the image of the extracted offset term, the size of a pattern 41, in other words, the size d′ of the pattern when viewed from the camera 20 is acquired.
(4) Based on the lens formula,

1/R1+1/b=1/f holds,

where b=(d′/d)·R1, and f is the focal length of the lens 21 in the camera 20.

When R1 is solved based on the above formula,

R1={(d′+d)/d′}·f

is obtained, and R1 can be calculated.

As the pattern 41, for example, an existing black ceramic portion formed on a windshield of an automobile may be used, a dimension between a plurality of reference points of the black ceramic portion may be a known interval, an interval having a known dimension may be set as the size d of the pattern 41. In this case, there is an advantage that it is not necessary to separately provide a reference portion.

The distance R between the camera 20 and the display 10 is obtained as follows. Note that the camera 20 is focused on the display 10 by electronic focus control.
(1) A pattern having a pattern of a known size d1 different from a sinusoidal pattern is displayed on the display 10 and is imaged by the camera 20.
(2) From the obtained image, a size d1′ of the pattern on the image (the size of the pattern when viewed from the camera 20) is acquired.
(3) Similarly to the above-described calculation of R1, R is calculated by the following expression based on the lens formula.

R={(d1′+d1)/d1′}·f

Since the distance R between the display 10 and the camera 20 and the distance R1 between the camera 20 and the transparent measurement object 100 can be calculated, the distance R2 between the display 10 and the transparent measurement object 100 can be obtained by

R2=R−R1.

The calculation of the distance R between the display 10 and the camera 20 is desirably performed before the measurement of the transparent measurement object 100. The distance R may be calculated each time the measurement is performed, or may be calculated when the positional relationship between the display 10 and the camera 20 is changed.

In addition, the calculation of the distance R is not limited to the above-described method, and in a case where the distance R between the display 10 and the camera 20 is known, the known value may be used. However, the method of calculating R using an image is desirable in that it is possible to easily cope with, for example, a case where the positional relationship between the display 10 and the camera 20 is changed and to quickly calculate an accurate distance R.

In addition, the calculation of the distance R1 between the camera 20 and the glass 100 may not be performed in parallel with the calculation of the diopter map, and may be performed in a separate process from the calculation of the diopter map. However, it is more efficient to perform the calculation of the distance R1 in parallel with the calculation of the diopter map. Further, the pattern 40 may not be formed on the plane of the glass 100, and a pattern having a known size d may be appropriately disposed at the disposition position of the glass 100 separately from the glass 100, the size d′ when the pattern is viewed from the camera 20 may be obtained to calculate the distance R1, and the glass 100 may be disposed instead of the pattern at the time of measurement to perform the measurement.

As described above, in this embodiment, the distance R1 from the camera 20 to the glass 100 is calculated based on the size d′ of the pattern 40 on the image captured when the pattern 40 is imaged by the camera 20 with the pattern (reference portion) 40 having the known size d disposed at the disposition position of the glass 100 set between the display 10 and the camera 20, on the focal length f of the camera 20, and on the actual size of the pattern 40, and the distance R2 from the display 10 to the glass 100 is calculated based on the calculated distance R1 and the distance R from the camera 20 to the display 10. The distance R2 is used to calculate the refractive power distribution of the glass 100, together with an image captured by the camera 20 in a state where the sinusoidal pattern is displayed on the display 10 and the glass 100 is disposed, and an image captured by the camera 20 in a state where the sinusoidal pattern is displayed on the display 10 but the glass 100 is absent.

That is, even when the glass 100 to be measured is changed, the distance R2 from the display 10 to the glass 100 required for the calculation of the refractive power distribution can be calculated with high accuracy each time, and thus highly accurate measurement is enabled.

Moreover, since the distance R from the camera 20 to the display 10 is calculated based on the size d1′ of the pattern on the image captured when the pattern of the known size d1 displayed on the display 10 is imaged by the camera 20 for which the electronic focus control is performed such that the focal position is located on the display 10 in a state, before measurement, in which the glass 100 is absent, on the focal length f of the camera 20, and on the actual size of the pattern, the distance R can be calculated each time before measurement, and the distance R2 can be calculated in a state where the distance R is accurate. Therefore, further highly accurate measurement of the refractive power distribution is enabled.

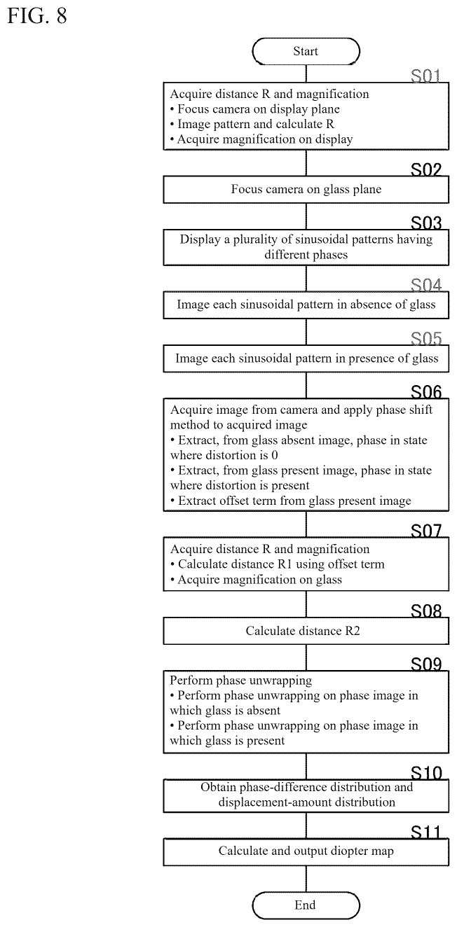

FIG. 8 is a flowchart illustrating processing up to calculation of a diopter map. In this processing, the operations of the display 10 and the camera 20 are performed under the control of the PC 30, and the acquisition of the image data from the camera 20 and the calculation processing are performed by the PC 30.

In step S01, the distance R from the camera 20 to the display 10 and the magnification are acquired. When a pattern having a known size is present on the plane of interest, the magnification is calculated back from the size and represents the amount of change [mm] per unit pixel when viewed from the camera 20. It can be calculated in the course of distance measurement. However, the pattern having the known size may be a sinusoidal pattern.

Specifically, the camera 20 is focused on the plane of the display 10, a pattern having a known size displayed on the display 10 is imaged by the camera 20, and the distance R from the display 10 to the camera 20 is calculated. Further, the magnification on the display 10 is acquired.

Next, in step S20, the camera 20 is focused on the plane of the glass 100 by electronic focus control, and then in step S03, a plurality of sinusoidal patterns having different phases are displayed on the display 10.

In step S04, each sinusoidal pattern is imaged by the camera 20 in the absence of the glass 100, and in step S05, each sinusoidal pattern is imaged by the camera 20 in the presence of the glass 100.

Next, in step S06, each image is acquired from the camera 20 and a phase shift method is applied to the acquired image. Note that the image acquisition from the camera 20 may be performed every time imaging is performed by the camera 20, or may be performed collectively after imaging of a fixed number of images or all of the images is performed.

In a phase shift method, a phase in a state where distortion is zero is extracted from the glass absent image, a phase in a state where distortion is present is extracted from the glass present image, and an offset term is extracted from the glass present image.

Next, in step S07, the distance R1 from the camera 20 to the glass 100 and the magnification are acquired. To be specific, the distance R1 is calculated using the offset term. Further, the magnification on the glass is acquired.

In step S08, the distance R2 from the display 10 to the glass 100 is calculated, and in step S09, phase unwrapping is performed on the phase image in which the glass is absent and the phase image in which the glass is present.

In step S10, a difference is calculated between the respective phase images to obtain a phase-difference distribution, and the angle is converted into the scale of the length to obtain a displacement-amount distribution. Then, in step S11, a refractive power (diopter) distribution of the glass 100 is calculated and output to an output apparatus such as a printer or a display apparatus (not illustrated).

Next, specific examples will be described.

### Example 1

A basic flow up to calculation of the diopter map will be described.

### (Experimental Conditions)

The basic system configuration is as illustrated in FIG. 3.

As the display 10, a display in which the number of pixels is 3840×2160 pixels, the size is 1228 mm×752 mm, the pixel pitch is 3 mm, and which is compatible with HDR signal input was used, and as the camera 20, a camera in which the number of pixels is 4896×3264 pixels, the pixel pitch is 5.5 μm, the focal length f of a lens is 100 mm, and a dynamic range is 12 bits was used. Further, a vehicle windshield sample was used as the transparent measurement object 100, and was supported by a support portion 200 (illustrated in FIG. 3) so as to have an inclination angle of 30° in accordance with an actual vehicle windshield.

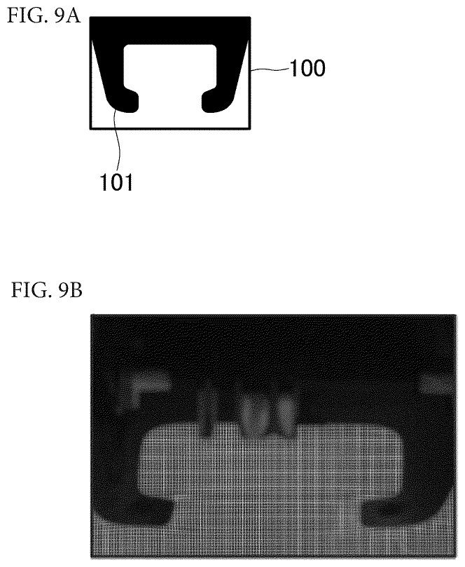

FIG. 9(A) is a front view of the transparent measurement object 100. The black portion is a black ceramic portion 101. To indicate a distorted portion, an image captured when a grid-like display pattern is displayed on the display 10 and is imaged by the camera 20 is illustrated in an enlarged manner in FIG. 9(B). It can be seen that distortion occurs in a part of the glass in the measurement region. In order to easily visualize the distortion, the electronic focus of the lens of the camera 20 is adjusted such that the display 10 is within the depth of focus.

### (Calculation of Distance R)

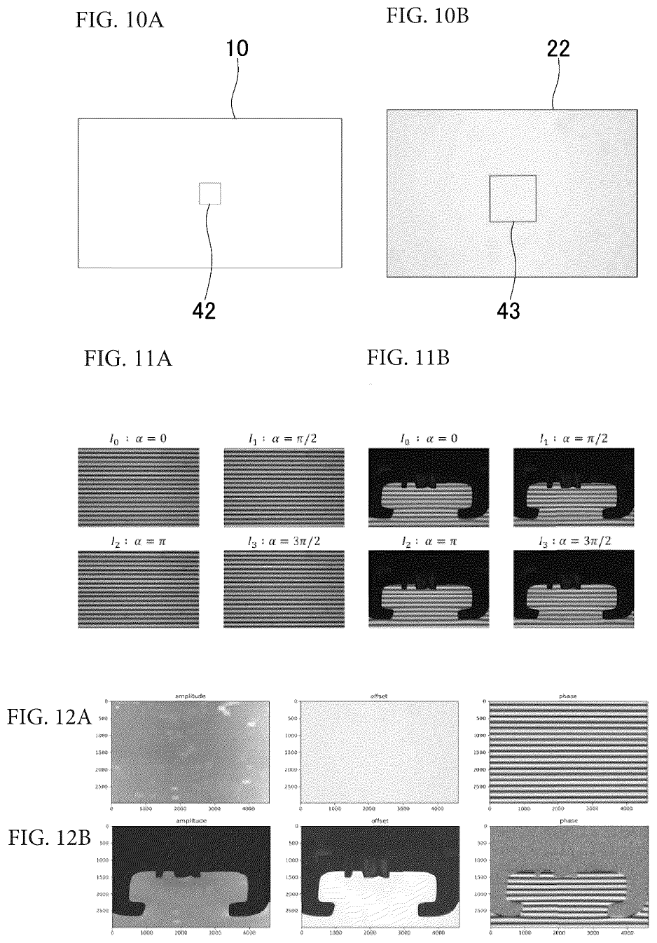

When, as illustrated in FIG. 10(A), a rectangular pattern 42 whose one side is d1=100 mm was displayed on the display 10, and was imaged by the camera 20, an image 43 illustrated in FIG. 10(B) was obtained.

As a result of the measurement, the on-image length d1′ of one side of the rectangular pattern 42 obtained by the sensor 22 was d1′=894 pixels×5.5 μm=4.92 mm. Therefore, the distance R from the display 10 to the camera 20 was determined based on R={(d1′+d1)/d1′}·f, resulting in

R={(4.92+100)/4.92}×100=2.13 m.

### (Measurement of Diopter)

Four types of sinusoidal patterns with initial phases α=0, α=π/2, α=π, and α=3/2π were displayed on the display 10, and were imaged by the camera 20 in the presence and absence of the glass 100. FIG. 11(A) illustrates images in the absence of the glass 100, and FIG. 11(B) illustrates images in the presence of the glass 100. Note that the size of one cycle of the sinusoidal pattern is 50 px.

Four-step phase shift method was applied to the above-described images to extract images of amplitudes, offsets, and phases. FIG. 12(A) illustrates extraction results in the absence of the glass 100, and FIG. 12(B) illustrates extraction results in the presence of the glass 100, both of the extraction results being the images of amplitudes, offsets, and phases in order from the left.

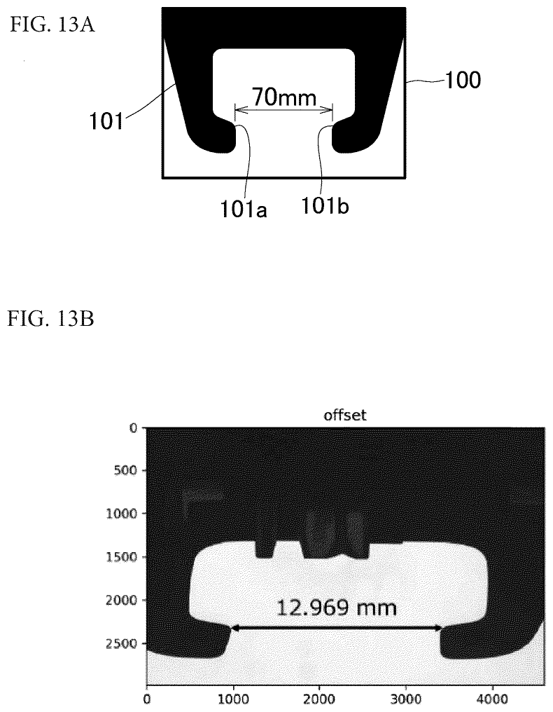

Next, the distance R1 from the camera 20 to the glass 100 is calculated using the above results. In this example, as illustrated in FIG. 13(A), the distance 70 mm between respective reference points 101a and 101b of two downward protrusions of the black ceramic portion 101 formed on the plane of the glass 100 is defined as the size d of the reference portion. From the offset image obtained as a result of the phase shift method and illustrated in FIG. 13(B) in the presence of the glass 100, the apparent size d′ of the reference portion when viewed from the camera 20 was d′=2358 pixels×5.5 μm=12.969 mm.

Therefore, using the fact that the focal length of the camera 20 is f=100 mm, the distance R1 is determined based on R1={(d′+d)/d′} ·f, resulting in

R1={(12.969+70)/12.969}×100=0.640 m.

Therefore, the distance R2 between the display 10 and the glass 100 is also automatically determined, resulting in

R2=R−R1=2.13-0.64=1.49 m.

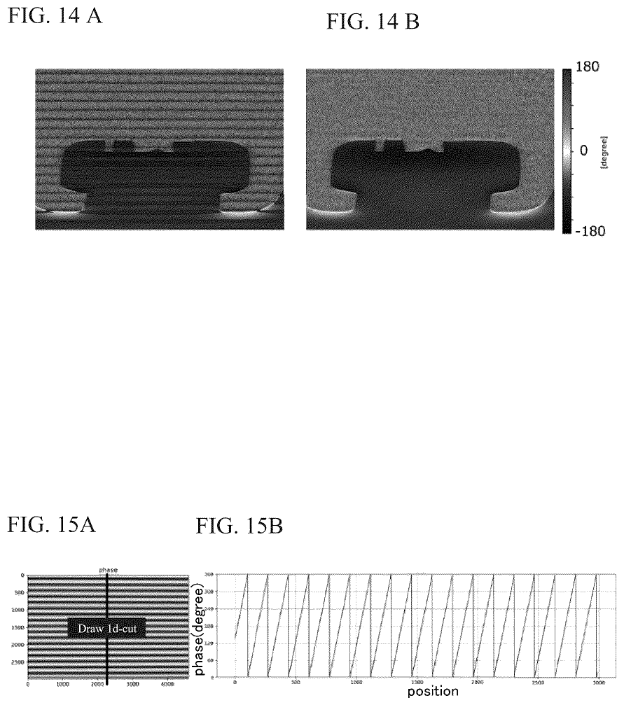

Next, a difference is calculated between phase images captured by the camera 20 in the presence and absence of the glass 100 to acquire a phase difference image as illustrated in FIG. 14(A). In addition, FIG. 14(B) illustrates an image obtained by performing phase unwrapping on the phase difference image.

Note that the scale of this image is an angle [degree], and it is necessary to convert the angle into the scale of the length to acquire the displacement-amount distribution. Therefore, a phase-length relationship is acquired using the phase image (the rightmost diagram in FIG. 12(A)) in the absence of the transparent measurement object 100.

To be specific, as illustrated in FIG. 15(A), a 1d-cut is drawn from the center of the phase image. FIG. 15(B) is a 1d-cut cross-sectional view of FIG. 15(A).

From the result of the 1d-cut, the phase-length relationship can be calculated as 0.0221 mm/degree. By multiplying the phase difference image illustrated in FIG. 14(B) by this value, the displacement-amount distribution can be acquired.

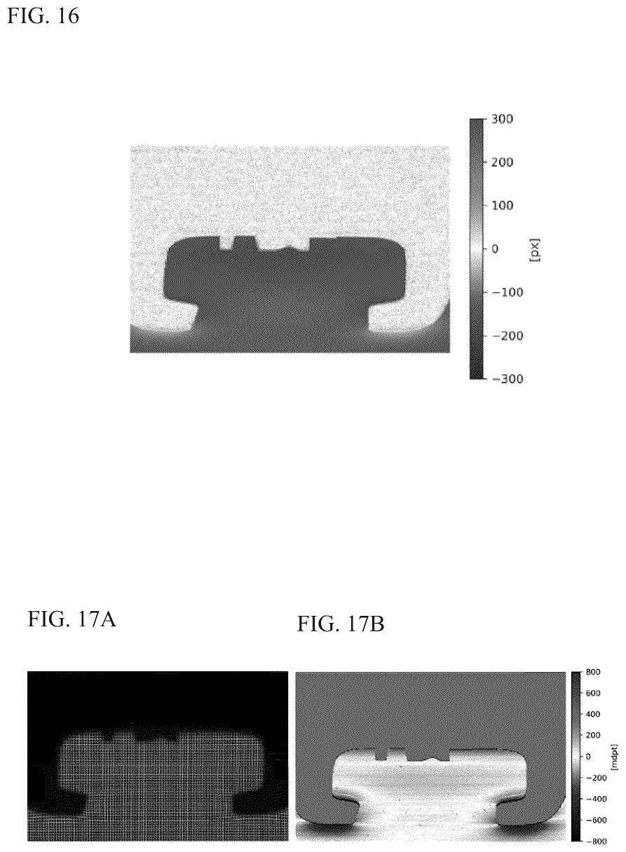

Next, as a countermeasure against noise at the time of calculation of the diopter map, an averaging filter is applied to the displacement-amount distribution. The kernel size was 15×15 pixels. The result is illustrated in FIG. 16.

When calculation of the diopter map was performed based on the displacement-amount distribution, the result illustrated in FIG. 17(B) was obtained. In comparison with the grid image (the same as that in FIG. 9(B)) illustrated in FIG. 17(A), a distorted portion corresponds to the diopter map. Note that the black ceramic portion 101 is masked in FIG. 17(B).

In FIG. 17(B), the black spot-like noise seen on the diopter map is considered to be dust or dirt present on the plane of the glass 100. Image processing may be separately performed so as to exclude such noise.

### Example 2

An example of a method of coping with a case where granular (salt-and-pepper) noise is present in the diopter map will be described.

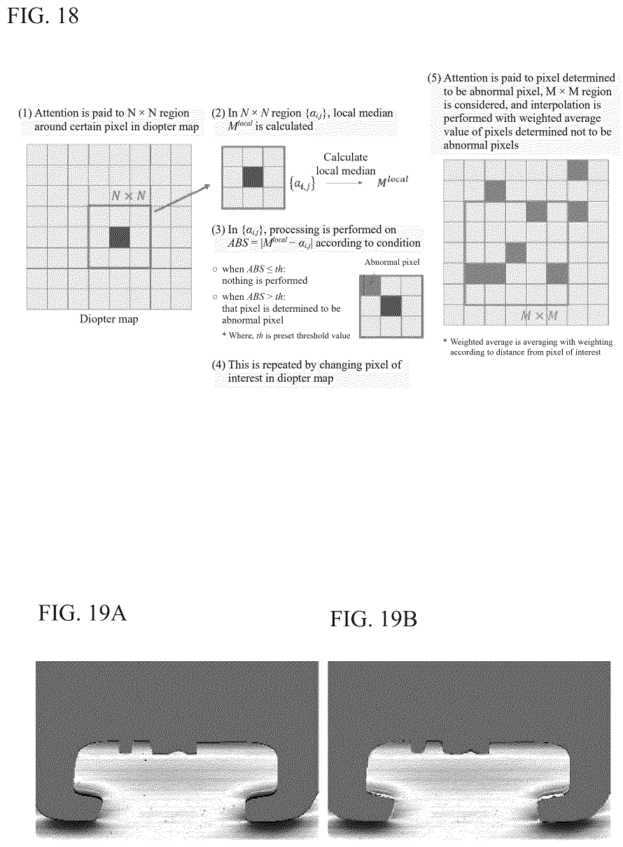

The processing illustrated in FIG. 18 and described below was performed on the diopter map.
(1) Attention is paid to an N×N region around a certain pixel in the diopter map.
(2) In the N×N region {a_{i,j}}, the local median M^{local} is calculated.
(3) In the region {a_{i,j}}, processing is performed on ABS=|M^{local}−a_{i,j}| according to the condition. That is, when ABS≤th, nothing is performed. When ABS>th, that pixel is determined to be an abnormal pixel. Note that th is a preset threshold value.
(4) This is repeated by changing the pixel of interest in the diopter map.
(5) Attention is paid to the pixel determined to be the abnormal pixel, an M×M region is considered, and interpolation is performed with a weighted average value of pixels determined not to be abnormal pixels. The weighted average is averaging with weighting according to the distance from the pixel of interest.

As a result of performing the processing (1) to (5), the diopter map calculated in Example 1 became the one illustrated in FIG. 19(B). Note that N=11 and th=140 were set. FIG. 19(A) illustrates a diopter map before the processing (1) to (5) is performed, and when both are compared with each other, it is found that granular noise indicated by black dots in FIG. 19(A) is reduced.

As described above, when granular noise is present in the diopter map of the glass 100, the absolute values of the differences between the local median in the diopter map and the surrounding pixel values are compared, determination is made, using the differences, whether the pixel is an abnormal pixel based on a threshold value, and when the pixel is determined to be the abnormal pixel, the pixel value of the abnormal pixel is replaced with the average value of the surrounding pixel values excluding the abnormal pixel, and therefore, even if granular noise due to dust, dirt, or the like is present in the diopter map, the granular noise can be reduced.

### Example 3

Gamma adjustment when the display 10 is used as a digital display apparatus will be described. In this embodiment, the diopter map is calculated based on the phase shift method. Since it is assumed that the sinusoidal pattern displayed on the display 10 is an ideal sinusoidal wave, if the display 10 is gamma-corrected and something different from a sinusoidal wave is displayed, it directly leads to an error in the output value.

Therefore, it is desirable to perform inverse gamma correction on the sinusoidal pattern on the display 10 such that the sinusoidal pattern displayed on the display 10 becomes as ideal a sinusoidal wave as possible.

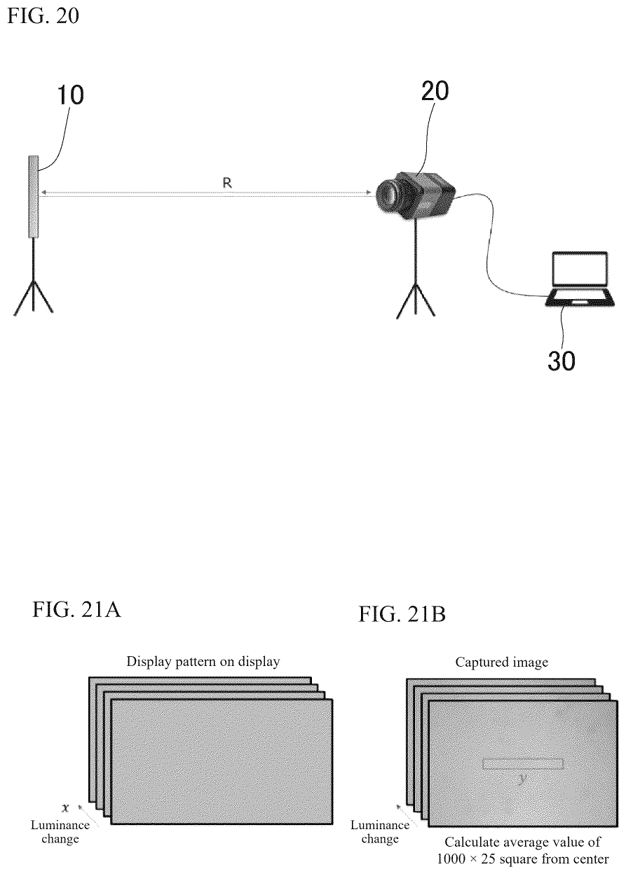

The inverse gamma correction was performed by the following method using the experimental optical system illustrated in FIG. 20.

### (Method)

(1) As illustrated in FIG. 21(A), an image in which the values of all the pixels are constant (x) is displayed on the display 10.
(2) A pattern displayed on the display 10 is imaged by the camera 20.
(3) As illustrated by a rectangular frame in FIG. 21(B), a certain region (e.g., a region of 1000×25 square from the center) from the center of the captured image is trimmed.
(4) An average value (=y) in the trimmed region is calculated.
(5) As illustrated in FIGS. 21(A) and 21(B), the value of x is changed, (1) to (5) are repeated N times, and x1, x2, - - - , and xn and y1, y2, - - - , and yn are acquired
(6) Real numbers a, γ, and b such that an error |y−y^{ideal}| between the y-x characteristics and the following function is minimized are determined. Note that y^{ideal}−ax^{γ}+b.
(7) The inverse gamma correction is performed using the acquired a, γ, and b.
   (a) A sinusoidal pattern is generated within the PC 30.
   (b) Each value s of the sinusoidal pattern is converted by the following expression. Note that Imax represents the maximum luminance value in the pattern image of (a). For example, when the number of bits of an image is 8 bits, Imax=255.

t=Imax·(s/Imax)^{1/γ}

In the experimental optical system illustrated in FIG. 20, the distance R between the display 10 and the camera 20, the maximum luminance Imax of the display 10, the constant image value x, and the size of the region to be trimmed were set as follows.
Distance R: 2.00 m
Maximum luminance Imax: 2¹⁶−1
Constant image value x: 6553, 9830, 13106, 16383, 19660, 22936, 26213, 29490, 32767, 36043, 39320, 42597, 45873, 49150, 52427, 55703, 58980, 62257, Size of region to be trimmed: 1000×25

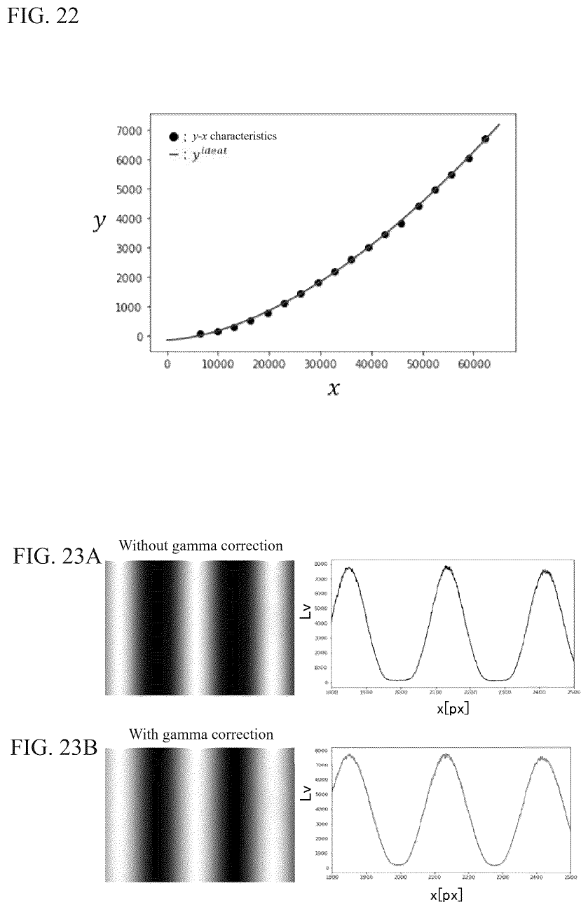

FIG. 22 illustrates the acquired y-x characteristics (black dots) and y^{ideal} (line). At this time, a=5.19×10⁻⁵, γ=1.69, and b=−1.28×10² were obtained.

When the gamma correction is applied to the generated sinusoidal pattern by using the acquired value of γ, a result illustrated in FIG. 23(B) was obtained. For comparison, FIG. 23(A) illustrates a sinusoidal pattern without gamma correction. It is found that the sinusoidal wave draws a more ideal curve by the gamma correction.

In this way, since the display 10 is subjected to gamma adjustment so as to maintain the linearity between the input luminance value and the output luminance value at the time of imaging by the camera 20, a more ideal sinusoidal pattern can be displayed on the display 10, and a further highly accurate diopter map can be obtained.

### Example 4

An influence on an output value due to a difference in spatial frequency of a sinusoidal pattern displayed on the digital display apparatus 10 will be described. In the present embodiment, since the transparent measurement object 100 is within the depth of focus of the camera 20 at the time of diopter measurement, the pattern image to be measured is basically defocused. Therefore, the spatial frequency of the sinusoidal pattern is limited.

Hereinafter, results obtained when the transparent measurement object 100 having a known diopter value is measured by changing the spatial frequency of the sinusoidal pattern will be described.

As illustrated in FIG. 24, an experimental optical system was used in which the display 10 and the camera 20 faced each other, and a plano-convex spherical lens 100 having a 50-mm diameter and a 2000-mm (=500 mdpt) focal length was disposed as the transparent measurement object between the display 10 and the camera 20. A distance R1 between the plano-convex spherical lens 100 and the camera 20 was set to 64 cm, and a distance R2 between the display 10 and the lens 100 was set to 149 cm.

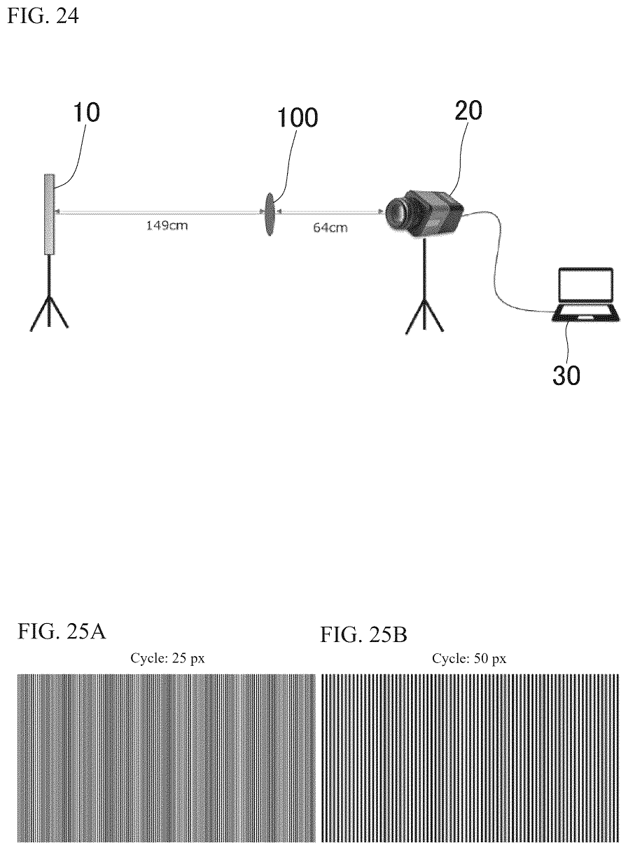

Two types of sinusoidal patterns having cycles of 25 px and 50 px (which have undergone inverse gamma correction and initial phases α=0) were displayed on the display 10. FIG. 25(A) illustrates a state where the sinusoidal pattern having the cycle of 25 px is displayed on the display 10, and FIG. 25(B) illustrates a state where the sinusoidal pattern having the cycle of 50 px is displayed on the display 10.

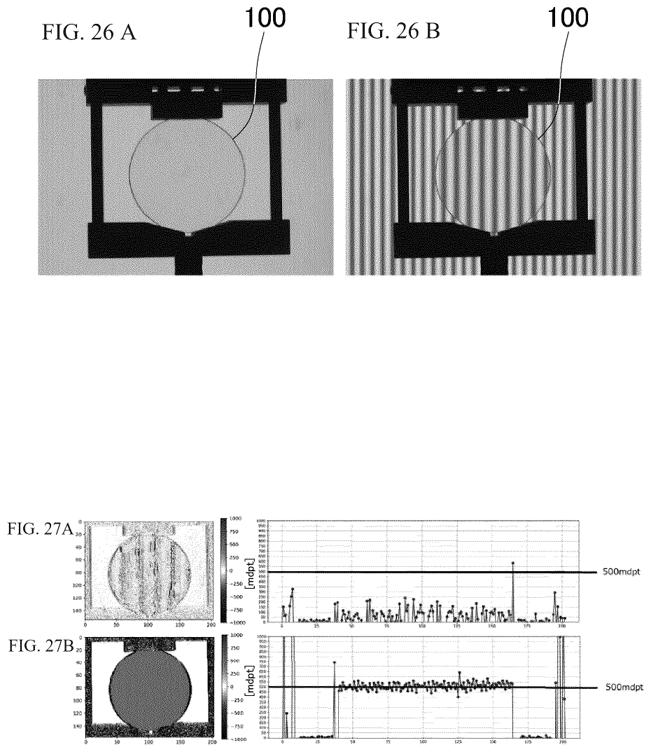

Images (initial phases α=0) of the sinusoidal patterns captured by the camera 20 in the presence of the measurement object (lens) 100 were as illustrated in FIGS. 26(A) and 26(B). FIG. 26(A) illustrates the case where the cycle of the sinusoidal pattern is 25 px, and FIG. 26(B) illustrates the case where the cycle of the sinusoidal pattern is 50 px.

Further, FIG. 27(A) is a diagram illustrating a diopter map in the case where the cycle of the sinusoidal pattern is 25 px and its horizontal-direction cross-sectional view, and FIG. 27(B) is a diagram illustrating a diopter map in the case where the cycle of the sinusoidal pattern is 50 px and its horizontal-direction cross-sectional view.

As illustrated in FIGS. 27(A) and 27(B), when the cycle is 25 px, a value of 500 mdpt cannot be detected. On the other hand, when the cycle is 50 px, the value of 500 mdpt can be detected. This is because when the cycle is 25 px, the influence of defocus is strong on the display pattern surface and the contrast of the sinusoidal wave is not sufficient. Generally, the contrast C is defined by the following expression, where the maximum value is Imax and the minimum value is Imin.

C−(Imax−Imin)/(Imax+Imin)

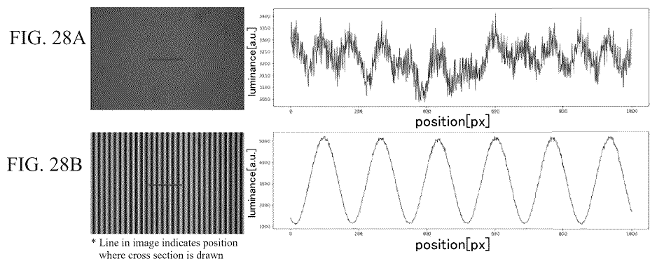

FIGS. 28(A) and 28(B) each illustrate a comparison result of contrast in a certain cross section of a sinusoidal image (initial phase α=0) in the absence of the measurement object 100. FIG. 28(A) illustrates the case where the cycle of the sinusoidal pattern is 25 px, and FIG. 28(B) illustrates the case where the cycle of the sinusoidal pattern is 50 px. The compared cross sections are horizontal cross sections with lengths of 1000 px at exactly the same positions of the sinusoidal images.

The contrast C calculated from the above is as follows.
(A) When the cycle is 25 px: C=0.06
(B) When the cycle is 50 px: C=0.66

From this result, it is found that the contrast of the sinusoidal distribution is desirably 10% or more. More preferably, when the contrast of the sinusoidal distribution is 30% or more, a highly accurate refractive power distribution can be obtained. Therefore, it is desirable to carefully set the spatial frequency of the pattern and the F-number of the camera.

In this way, by adjusting the spatial frequency of the sinusoidal pattern such that the contrast is 10% or more at the time of imaging by the camera 20, it is possible to obtain a further highly accurate diopter map.

This application claims the benefit of priority to Japanese Patent Application No. 2022-199430 filed on Dec. 14, 2022, the disclosure of which is incorporated herein by reference in its entirety.

### INDUSTRIAL APPLICABILITY

The present invention is applicable to, for example, measurement of a refractive power distribution of a transparent measurement object such as a windshield of an automobile.

### REFERENCE SIGNS LIST

10 display
20 camera (imaging apparatus)
21 lens
22 imaging sensor
30 PC (personal computer)
40 pattern (reference portion)
41 pattern on image
42 pattern
43 pattern on image
100 transparent measurement object
101 black ceramic portion
101a, 101b reference point
200 support portion

1. A system for measuring optical characteristics of a transparent measurement object, the system comprising:
a display apparatus capable of displaying a display pattern in a light emission manner;
an imaging apparatus disposed at a distance from the display apparatus and capable of performing electronic focus control;
a distance calculator that calculates a first distance from the imaging apparatus to the transparent measurement object disposed at a disposition position of the transparent measurement object set between the display apparatus and the imaging apparatus, based on a size of a reference portion on an image captured when the reference portion having a known size is disposed at the disposition position and is imaged by the imaging apparatus, on a focal length of the imaging apparatus, and on an actual size of the reference portion, and calculating a third distance from the display apparatus to the transparent measurement object based on the first distance calculated and a second distance from the imaging apparatus to the display apparatus; and
a calculator that calculates a refractive power distribution of the transparent measurement object based on an image captured by the imaging apparatus in a state where the display pattern is displayed on the display apparatus and the transparent measurement object is disposed at the disposition position, on an image captured by the imaging apparatus in a state where the display pattern is displayed on the display apparatus but the transparent measurement object is absent, and on the third distance calculated by the distance calculator.

2. The system for measuring optical characteristics of a transparent measurement object according to claim 1, wherein the reference portion and the transparent measurement object are imaged by the imaging apparatus in a state where the electronic focus control is performed such that the reference portion and the transparent measurement object are within a depth of focus of the imaging apparatus.

3. The system for measuring optical characteristics of a transparent measurement object according to claim 1, wherein the display apparatus is subjected to gamma adjustment so as to maintain linearity between an input luminance value and an output luminance value at a time of imaging by the imaging apparatus.

4. The system for measuring optical characteristics of a transparent measurement object according to claim 1, wherein the display pattern includes a plurality of patterns in which brightness and darkness change sinusoidally and phases of a sinusoidal wave are different from each other, and a spatial frequency is adjusted such that contrast is 10% or more at a time of imaging by the imaging apparatus.

5. The system for measuring optical characteristics of a transparent measurement object according to claim 1, wherein the distance calculator calculates the second distance based on a size of a pattern on an image captured when the pattern having a known size displayed on the display apparatus is imaged by the imaging apparatus for which the electronic focus control is performed such that a focal position is located on the display apparatus in a state before the transparent measurement object is imaged and where the transparent measurement object is absent, on a focal length of the imaging apparatus, and on an actual size of the pattern.

6. The system for measuring optical characteristics of a transparent measurement object according to claim 1, wherein
the transparent measurement object is a windshield of an automobile, and
the reference portion is a black ceramic portion in which a plurality of reference points formed on the windshield and a dimension of an interval between the reference points are known.

7. The system for measuring optical characteristics of a transparent measurement object according to claim 1, wherein when granular noise is present in the refractive power distribution of the transparent measurement object that is a calculation result, the calculator compares absolute values of differences between a local median in the refractive power distribution and surrounding pixel values, determines, using the differences, whether a pixel is an abnormal pixel based on a threshold value, and when the pixel is determined to be the abnormal pixel, performs processing of replacing a pixel value of the abnormal pixel with an average value of surrounding pixel values excluding the abnormal pixel.

8. A method for measuring optical characteristics of a transparent measurement object, the method comprising:
disposing a reference portion having a known size at a disposition position of the transparent measurement object set between a display apparatus capable of displaying a display pattern in a light emission manner and an imaging apparatus disposed at a distance from the display apparatus and capable of performing electronic focus control, and imaging the reference portion by the imaging apparatus;
calculating a first distance from the imaging apparatus to the transparent measurement object disposed at the disposition position, based on a size of the reference portion on an image captured by imaging the reference portion, a focal length of the imaging apparatus, and an actual size of the reference portion, and calculating a third distance from the display apparatus to the transparent measurement object based on the first distance calculated and a second distance from the imaging apparatus to the display apparatus;
imaging by the imaging apparatus in a state where the display pattern is displayed on the display apparatus and the transparent measurement object is disposed at the disposition position and in a state where the display pattern is displayed on the display apparatus, but the transparent measurement object is absent; and
calculating a refractive power distribution of the transparent measurement object based on an image in which the transparent measurement object is present and an image in which the transparent measurement object is absent, the images having been captured by imaging by the imaging apparatus, and on the third distance calculated.

9. A non-transitory computer-readable recording medium storing a program for causing a computer to execute:
acquiring an image of a reference portion captured by an imaging apparatus in a state where the reference portion having a known size is disposed at a disposition position of a transparent measurement object set between a display apparatus and the imaging apparatus, the display apparatus being capable of displaying a display pattern in a light emission manner, the imaging apparatus being disposed at a distance from the display apparatus and capable of performing electronic focus control;
calculating a first distance from the imaging apparatus to the transparent measurement object disposed at the disposition position, based on a size of the reference portion on the image acquired, a focal length of the imaging apparatus, and an actual size of the reference portion, and calculating a third distance from the display apparatus to the transparent measurement object based on the first distance calculated and a second distance from the imaging apparatus to the display apparatus;
acquiring an image captured by the imaging apparatus in a state where the display pattern is displayed on the display apparatus and the transparent measurement object is disposed at the disposition position, and an image captured by the imaging apparatus in a state where the display pattern is displayed on the display apparatus, but the transparent measurement object is absent; and
calculating a refractive power distribution of the transparent measurement object based on the image in which the transparent measurement object is present and the image in which the transparent measurement object is absent, the images having been acquired, and on the third distance calculated.
